(19) United States
(12) Patent Application Publication
(10) Pub. No.: US 2005/0095463 A1
(43) Pub. Date: May 5, 2005

(54) Magnetic disk and magnetic disk apparatus using the same

(75) Inventors: Takanori Furusawa, Ome-shi (JP); Masato Fujii, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/976,155

(22) Filed: Oct. 29, 2004

(30) Foreign Application Priority Data
Oct. 31, 2003 (JP) 2003-373626

(51) Int. Cl. G11B 17/02

(52) U.S. Cl. 428/694 TR; 428/694 TS

(57) ABSTRACT

A magnetic disk includes a substrate, a magnetic recording film and a protective film which are stacked on a surface of the substrate and form an external surface of the substrate, and a lubricant containing particulate fullerenes and provided on the external surface of the substrate. A maximum surface roughness Rmax of the external surface of the substrate is smaller than a diameter L of the fullerenes.

### CROSS-REFERENCE TO RELATED APPLICATIONS

This application is based upon and claims the benefit of priority from prior Japanese Patent Application No. 2003-373626, filed Oct. 31, 2003, the entire contents of which are incorporated herein by reference.

### BACKGROUND OF THE INVENTION

1. Field of the Invention

This invention relates to a magnetic disk which can perform high-density magnetic recording, and a magnetic disk apparatus equipped with the magnetic disk.

2. Description of the Related Art

Generally, a magnetic disk apparatus has a magnetic disk arranged in a case, a spindle motor which supports and drives the magnetic disk, and a head suspension assembly including a magnetic head which performs read/write of information to the magnetic disk.

The head suspension assembly has a slider on which the magnetic head is formed, a suspension which supports the slider, and an arm which supports the suspension. The head suspension assembly is rotatably supported by a bearing assembly. The head suspension assembly is rotated by a voice coil motor, and thereby the magnetic head is moved to a desired position on the magnetic disk.

In the magnetic disk apparatus having the above structure, to prevent change in behavior of the slider and scratch on the magnetic disk due to accidental contact between the magnetic head and the magnetic disk, it is necessary to apply a lubricant onto the surface of the magnetic disk and increase the surface roughness of the magnetic disk to reduce the adsorptive activity of the slider to the magnetic disk. In conventional magnetic disk apparatuses, the flying height of the magnetic head from the magnetic disk is 10.0 nm or more. Therefore, even in the case of using a magnetic disk having projecting portions with a height (hereinafter referred to as “projection height”) of 4.0 nm or more on the surface thereof, it is possible to secure a flying margin of the magnetic head, that is, the minimum distance between the magnetic head and the magnetic disk in consideration of many variable factors. Thus, it is possible to maintain the flying stability of the magnetic head.

However, in recent years, the recording density of magnetic disks has reached 70 GB/inch², and it is required to set the flying height of the magnetic head to 10.0 nm or less. Under such circumstances, the flying margin of the magnetic head is lost if the projection height of the magnetic disk surface is 4.0 nm or more. This causes thermal asperity (fluctuations in MR (magnetoresistance) sensor output of the magnetic head due to heat generated by collision of the magnetic head with projections) and deterioration in the reliability.

In recent years, to increase the SN ratio of the electromagnetic property, it has been tried to provide magnetic anisotropy to the magnetic disk by providing texture processing to the substrate of the magnetic disk. More specifically, the magnetization easy axis of a Co alloy layer being the magnetic recording layer is oriented in the circumferential direction by the texture processing, and the remanent magnetism and squareness ratio in the circumferential direction are relatively higher than those in the radial direction of the magnetic disk. Since the reproducing output increases in almost proportion to the remanent magnetism, it is possible to reduce the thickness of the magnetic layer, and consequently improve the magnetization transition width, the noise and the overwrite property. Specifically, texture media (anisotropic media) subjected to the texture processing are improved in the resolution, the half-value width, and the S/N ratio, and have a great advantage as high-recording-density media. Therefore, it is influential means for achieving higher recording density to bring texture media into practical use.

However, the texture processing simultaneously removes the projecting portions (projections) of the disk surface, and tends to greatly reduce the surface roughness of the magnetic disk. As a result, the adsorptive activity of the magnetic head to the magnetic disk is increased. Therefore, to obtain a high-reliable medium, it is required to prevent fluctuation in behavior of the slider and scratch on the magnetic disk due to contact between the magnetic head and the magnetic disk, and simultaneously reduce the adsorptive activity of the slider to the magnetic disk.

In the meantime, recently, fullerenes have received attention as material having a high lubricity. For example, Japanese Patent No. 2817502 proposes a magnetic recording medium having a solid lubricating layer formed of an alkyl chain or aryl chain adduct of fullerenes. The solid lubricating layer is formed by depositing fullerenes on a protective film of sputter carbon.

Further, Jpn. Pat. Appln. KOKAI Pub. No. 7-235045 proposes a bearing using a lubricating film containing fullerene molecules or its derivatives. The lubricating film is formed by dissolving fullerenes in toluene or the like, applying the solution and thereafter volatilizing the toluene. After volatilizing the toluene, residual fullerenes function as solid lubricant. Furthermore, Jpn. Pat. Appln. KOKAI Pub. No. 2001-67644 proposes an applying agent serving as a lubricating applying agent for a magnetic recording apparatus, in which fullerenes having hydrophobic substituents are dispersed in a solvent.

A minimum and basic fullerene is a soccer-ball-shaped C₆₀, and has a diameter of 0.7 nm. In addition, there are a football-shaped fullerene and a dumbbell-shaped fullerene, etc. Further, as a giant fullerene, known is an onion fullerene having a laminated structure. For example, Japanese Patent No. 3074170 proposes a method of preparing a nanometer spherical onion fullerene having almost the same size as that of carbon nanoparticles which are the material thereof, by irradiating the carbon nanoparticles with a high-energy beam such as an electron beam.

As described above, although fullerenes are useful as lubricant, it is difficult to directly use fullerenes as lubricant of magnetic disks. For example, the maximum surface roughness Rmax of a magnetic disk subjected to texture processing is several nanometers. The maximum surface roughness Rmax indicates the maximum value of the depth or height from the center line of the surface height to depressed portions or projecting portions. In comparison with this, the diameter L of particulate fullerenes is generally 0.7 nm. Therefore, particulate fullerenes are embedded in depressions on the surface of the magnetic disk, and difficult to contact the magnetic head and the like. As a result, it is impossible to obtain a lubricating effect using fullerenes. Actually, the depth of depressed grooves is several nanometer, while the width of the depressions is several μm. Although the horizontal distance is actually about 1000 times as large as the vertical distance, fullerenes are still embedded in the depressions.

### BRIEF SUMMARY OF THE INVENTION

According to an embodiment of the present invention, a magnetic disk comprises: a substrate; a magnetic recording film and a protective film which are stacked on a surface of the substrate and form an external surface of the substrate; and a lubricant containing particulate fullerenes and provided on the external surface of the substrate, a maximum surface roughness Rmax of the external surface of the substrate being smaller than a diameter L of the fullerenes.

According to another embodiment of the present invention, a magnetic disk apparatus comprises: the magnetic disk; a driving section which supports and drives the magnetic disk; a magnetic head which performs recording and reproducing of information to the magnetic disk, and has a flying height FH to the external surface of the magnetic disk, the flying height FH being larger than the diameter L of the fullerenes; and a head suspension assembly which supports the magnetic head.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a plan view of an HDD according to an embodiment of the present invention.

FIG. 2 is an enlarged side view of a magnetic head portion in the HDD.

FIG. 3 is a cross-sectional view of a magnetic disk according to the embodiment of the present invention.

FIGS. 4A to 4C are enlarged schematic cross-sectional views of an external surface of the magnetic disk.

FIG. 5 is a diagram illustrating a basic structure of a fullerene.

### DETAILED DESCRIPTION OF THE INVENTION

An embodiment of the present invention, which is applied to a hard disk drive (hereinafter referred to as “HDD”), will be described in detail below, with reference to the drawings.

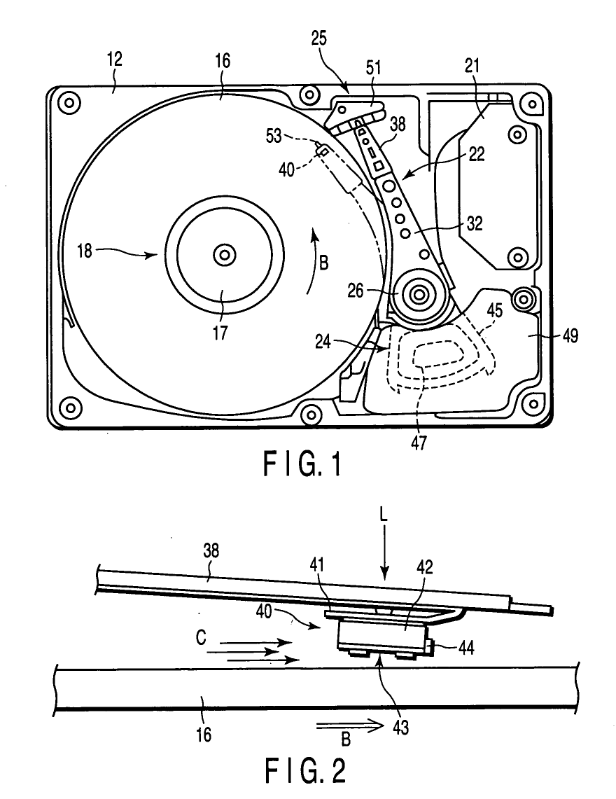

As shown in FIG. 1, the HDD has a rectangular box-shaped case 12 with an opened top, and a top cover (not shown) which is fixed to the case by screws to cover the top opening of the case.

In the case 12, contained are two magnetic disks 16 (only one is shown) serving as recording media, a spindle motor 18 which serves as a driving section to support and rotate the magnetic disks, a plurality of magnetic heads which perform writing/reading of information to the magnetic disks, a carriage assembly 22 which supports the magnetic heads movably with respect to the magnetic disks 16, a voice coil motor (hereinafter referred to as “VCM”) which rotates and positions the carriage assembly, a ramp loading mechanism 25 which retains the magnetic heads in a receded position distant from the magnetic disks when the magnetic heads move to the outermost periphery of the magnetic disks, and a board unit 21 having a read/write amplifier being a processing circuit for recording/reproducing signals.

On an outer surface of the bottom wall of the case 12, screwed is a printed circuit board (not shown) which controls operations of the spindle motor 18, the VCM 24, and the magnetic heads through the board unit 21.

Each of the magnetic disks 16 has a magnetic recording layer on its top surface and bottom surface. The two magnetic disks 16 are fitted onto an outer periphery of a hub (not shown) of the spindle motor 18, and fixed and supported on the hub by a clamp spring 17. Thereby, the two magnetic disks 16 are coaxially arranged in a stacked manner with a predetermined space between them. By driving the spindle motor 18, the two magnetic disks 16 are rotated as one unitary piece in a direction of arrow B at a predetermined speed, for example, 4200 rpm.

The carriage assembly 22 has a bearing portion 26 fixed onto the bottom wall of the case 12, and a plurality of arms 32 extending from the bearing portion 26. The arms 32 are arranged at regular intervals and in parallel to the surfaces of the magnetic disks 16, and extend from the bearing portion 26 in the same direction. The carriage assembly 22 has elongated plate-shaped suspensions 38 which are elastically deformable. Each suspension 38 is formed of a leaf spring. The proximal ends of the suspensions 38 are fixed to respective distal ends of the arms 32, and extend from the respective arms 32. Each suspension 38 may be formed as one unitary piece with the corresponding arm 32. A head suspension is formed by one arm 32 and one corresponding suspension 38, and a head suspension assembly is formed by one head suspension and one corresponding magnetic head.

As shown in FIG. 2, each magnetic head 40 has a substantially rectangular slider 42, and a recording/reproducing head portion 44 formed on an end portion of the slider. Each magnetic head 40 is fixed to a gimbal spring 41 provided on a distal end portion of the corresponding suspension 38. A head load L toward the surface of the magnetic disk 16 is applied to each magnetic head 40 by elasticity of the corresponding suspension 38. In operation, the flying height of the magnetic heads 40 from the surface of the magnetic disks 16 is set to 10.0 nm or less, for example, 7 nm.

As shown in FIG. 1, the carriage assembly 22 has a support frame 45 extending from the bearing portion 26 in the opposite direction of the arms 32. The support frame 45 supports a voice coil 47 which forms a part of the VCM 24. The support frame 45 is formed of synthetic resin and formed as one unitary piece around the outer periphery of the voice coil 47. The voice coil 47 is located between a pair of yokes 49 secured on the case 12, and forms the VCM 24 together with these yokes and a magnet (not shown) fixed to one of the yokes. The carriage assembly 22 is rotated around the bearing portion 26 by energizing the voice coil 47, and the magnetic heads 40 are moved and positioned onto desired tracks of the magnetic disks 16.

The ramp loading mechanism 25 has a ramp 51 which is provided on the bottom wall of the case 12 and arranged outside the magnetic disks 16, and tabs 53 extending from the distal ends of the respective suspensions 38. When the carriage assembly 22 is rotated to the receded position outside the magnetic disks 16, the tabs 53 are engaged with respective ramp surfaces formed on the ramp 51. Thereafter, the tabs 53 are raised by virtue of inclination of the ramp surfaces, and the magnetic heads 40 are unloaded.

Next, the magnetic disks 16 in the HDD are explained in detail.

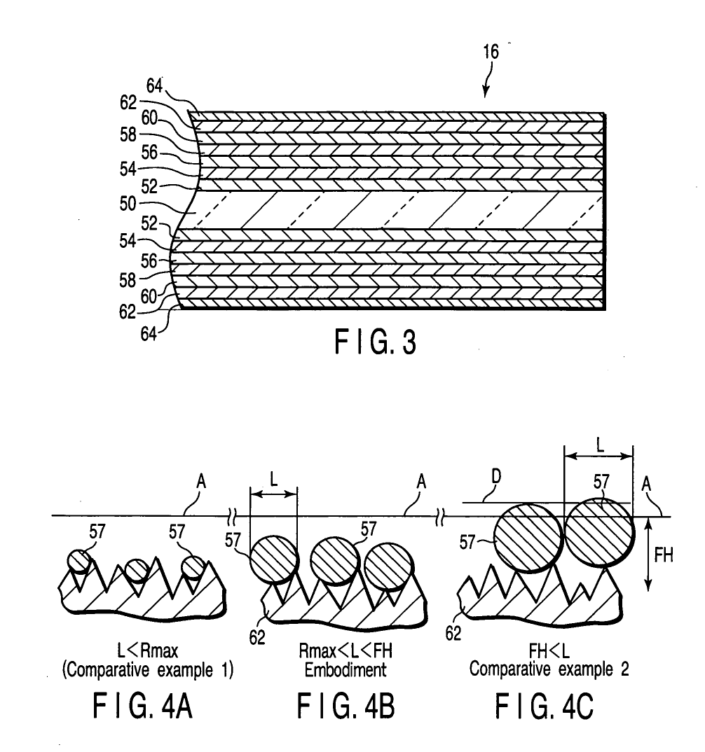

As shown in FIG. 3, each magnetic disk 16 has a substrate 50 which is a crystallized glass substrate or a tempered glass having a thickness of 0.3 to 1 mm and a diameter of 0.5 to 3.5 inches. Surfaces of the substrate 50 are subjected to polishing by abrasive slurry. Further, the surfaces of the substrate 50 are subjected to texture processing in the circumferential direction by diamond slurry or the like, that is, processing to provide the surfaces of the substrate with grooves extending in the circumferential direction and provide magnetic anisotropy. Thereby, each of the magnetic disks 16 is formed as a so-called texture medium.

A multilayer film is formed on each of the surfaces of the substrate 50 by sputtering. Specifically, a first base film 52, and a second base film 54 are stacked on each surface of the substrate 50. On each second base film 54, a stabilizing film 56, an intermediate film 58, a magnetic recording film 60, and a protective film 62 formed of carbon or the like are successively formed.

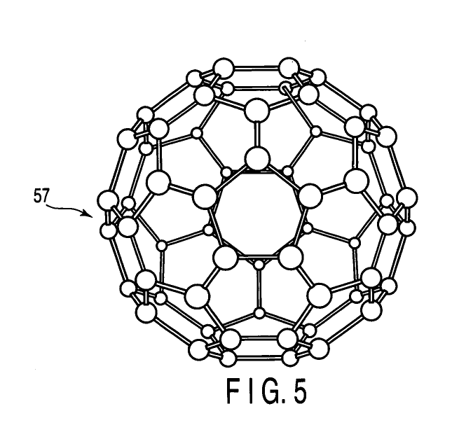

As shown in FIGS. 3 and 4B, a lubricating film 64 is formed on each protective film 62 by, for example, applying a fluorine-based lubricant containing particulate fullerenes 57. FIG. 5 illustrates a soccer-ball-shaped C₆₀ as an example of a basic fullerene. In this embodiment, so-called onion fullerenes are used as fullerenes 57.

If the maximum surface roughness of the external surfaces of the magnetic disks 16 (surfaces of the protective films 62 in this embodiment) is Rmax and the diameter of the fullerenes 57 is L, the surfaces of the protective films 62 and the fullerenes 57 are formed such that they satisfy the following relationship.
Rmax<L

For example, the maximum surface roughness Rmax of the surface of each protective film 62 is set to 2 nm, and the diameter L of the fullerenes 57 is set to 3 to 5 nm.

Further, as shown by line A in FIG. 4B, if a target flying height of the magnetic heads 40 to the external surface of the magnetic disk 16 is FH, the target flying height FH and the diameter L of the fullerenes 57 are set to satisfy the following relationship.
L<FH

For example, the target flying height FH is set to 7 nm. Therefore, the maximum surface roughness Rmax of the external surfaces of the magnetic disks 16, the diameter L of the fullerenes 57, and the, flying height FH of the magnetic heads 40 are set to satisfy the following relationship.
Rmax<L<FH

According to the magnetic disks 16 configured as described above and the HDD having the magnetic disks, the external surfaces of the magnetic disks are formed such that the maximum surface roughness Rmax of the external surfaces thereof is set to be smaller than the diameter L of the fullerenes 57. Therefore, the fullerenes 57 are not embedded in the depressions of the external surfaces of the magnetic disks, and can fully function as lubricant of the magnetic disks. Thereby, it is possible to obtain a magnetic disk which is excellent in lubricity. Consequently it is possible to prevent damage to the magnetic heads 40 due to accidental collision of the magnetic heads with the surfaces of the magnetic disks 16, and prevent adsorption of the magnetic heads to the surfaces of the magnetic disks. This provides a magnetic disk and an HDD which achieve both high recording density and high reliability.

If L is smaller than Rmax as in Comparative Example 1 shown in FIG. 4A, fullerenes 57 are embedded in depressions on the external surfaces of the magnetic disks, and cannot fully function as lubricant. In the meantime, as in Comparative Example 2 shown in FIG. 4C, if the flying height FH of the magnetic heads 40 is smaller than the diameter L of the fullerenes 57 and the relationship “FH<L” is established, the magnetic heads 40 contact the fullerenes 57 as shown by line D, and the flying height thereof exceeds the target flying height. In such a case, the magnetic heads 40 cannot obtain a required electromagnetic conversion property, and the performance of the HDD deteriorates.

In contrast with this, according to this embodiment of the present invention, the flying height FH of the magnetic heads is larger than the diameter L of the fullerenes 57 and the relationship “FH<L” is established. Therefore, a desired head flying height can be obtained, with high lubricity of the magnetic disk surfaces maintained.

The present invention is not limited to the above embodiment, but can be carried out by modifying the constituent elements within the range of not departing from the gist of the invention. Further, various inventions can be made by properly combining a plurality of constituent elements disclosed in the above embodiment. For example, some of the constituent elements may be removed from the constituent elements disclosed in the embodiment. Further, constituent elements of different embodiments may be combined according to necessity.

For example, in the above embodiment, the lubricating film is formed by applying a liquid lubricant containing fullerenes and thereafter drying the lubricant. However, fullerenes may be formed on the surfaces of the magnetic disks 16 as solid lubricant forming a one unitary piece with the protective films, by depositing fullerenes on protective films containing carbon and fixing them thereon.

Further, in the magnetic disks, the materials and thickness and the like of the base films, recording films, and intermediate films, etc. are not limited to those in the above embodiment, but can be variously selected according to necessity. The present invention is also applicable to magnetic disks which are not subjected to texture processing. In the magnetic disk apparatus, the number of the magnetic disks is not limited to two, but may be increased or reduced according to necessity.

1. A magnetic disk comprising:
a substrate;
a magnetic recording film and a protective film which are stacked on a surface of the substrate and form an external surface of the substrate; and
a lubricant containing particulate fullerenes and provided on the external surface of the substrate,
a maximum surface roughness Rmax of the external surface of the substrate being smaller than a diameter L of the fullerenes.

2. The magnetic disk according to claim 1, wherein the external surface of the substrate is subjected to texture processing which provide a circumferential magnetic anisotropy to the external surface, and the magnetic disk has the circumferential magnetic anisotropy.

3. The magnetic disk according to claim 1, wherein the lubricant forms a lubricating film containing the fullerenes.

4. The magnetic disk according to claim 1, wherein the lubricant is formed as one unitary piece with the protective film containing the fullerenes and carbon.

5. A magnetic disk apparatus comprising:
a magnetic disk according to claim 1;
a driving section which supports and drives the magnetic disk;
a magnetic head which performs recording and reproducing of information to the magnetic disk, and has a flying height FH to the external surface of the magnetic disk, the flying height FH being larger than the diameter L of the fullerenes; and
a head suspension assembly which supports the magnetic head.

6. The magnetic disk apparatus according to claim 5, wherein the external surface of the substrate is subjected to texture processing which provide a circumferential magnetic anisotropy to the external surface, and the magnetic disk has the circumferential magnetic anisotropy.

7. The magnetic disk apparatus according to claim 5, wherein the lubricant forms a lubricating film containing the fullerenes.

8. The magnetic disk apparatus according to claim 5, wherein the lubricant is formed as one unitary piece with the protective film containing the fullerenes and carbon.
